(19) United States
(12) Patent Application Publication
(10) Pub. No.: US 2005/0198796 A1
(43) Pub. Date: Sep. 15, 2005

(54) Axel popper

(76) Inventor: Steven Scott Hamrick, Kent, OH (US)

Correspondence Address: Steven Hamrick, 7654 Newton Falls Rd., Ravenna, OH, 44240, US

(21) Appl. No.: 10/668,990

(22) Filed: Sep. 22, 2003

Related U.S. Application Data
(60) Provisional application No. 60/413,085, filed on Sep. 24, 2002.

(51) Int. Cl. B23P 19/04

(52) U.S. Cl. 29/239

(57) ABSTRACT

A hand held forked separator(s) or a forked wedge separator(s) used with or without a hand held hammer or hitting device (including air hammer). A U shape is on one side of the tool and on the other side of the U is a handle. There are different lengths of the tool available. Such as the 9″, 12″, 15″, 18″ etc. These are used in combination with any hand held hammer or hitting device or as a prybar or with a shim (same tool but without a tapered fork). They are made to be used for the removal of c/v halfshafts from front wheel drive and rear wheel drive with front wheel drive set up transaxle automobiles. This tool is driven straight in between the inner c/v joint housing and the transaxle. Then sideways to finish knocking it out or just sideways if the gap between the transaxle and the inner c/v joint housing allows the the tool to slide in, the straight way, without any necessary hammering. The shim version of the tool is also used in these cases. (same tool but without a tapered fork).

This application claims priority under 35 U.S.C. 119(e) to U.S. provisional application 60/413085 filed Sep. 24, 2002.

### BACKGROUND OF INVENTION

Fork wedge separators have been around for many years. They have many uses and the idea of them is not new. As automobiles have changed over the years so has the tooling changed to keep up within the need for repair in an efficient and inexpensive way. With the introduction of the front wheel drive transaxle in the auto industry. We were given the c/v halfshaft. These have to be removed for a number of reasons. To remove, repair or replace the transaxle. To replace the seal for the c/v halfshaft and or to repair or replace the c/v halfshaft, boot or the c/v joint itself. Some c/v shafts will come out with little force. But almost all of them require a good to great forcing out. Mechanics almost always use some kind of prybar to get them out. Hard work and danger of the prybar slipping. A prybar is not supported on both sides. Sometimes the prybar wont even get the c/v shaft out at all. Furthermore if the mechanic does not have the benefit of a car lift and is working on the ground. He/She doesn't have any room to get a prybar in place. On a hard to get out shaft it makes for an impossible part of the job and is very dangerous if the car is on a jack or blocks. The prying action can push the car over causing it to fall.

There are special tools designed for removing the c/v shaft. Like the J-35910. This tool has to be assembled to a slidehammer. This can be expensive given the attachments and all. It is also clumsy and requires generous space to be used. In a lot of cases it wont even fit in between the transaxle and the halfshaft or take it out to begin with. Thus wasted time money and space.

There are other forked wedge separators. None are made to do the job of removing the c/v halfshaft from front wheel drive and rear wheel drive autos with front wheel drive set up transaxles.

Pattersons U.S. Pat. No. 5,103,544. This tool is an attachment for an air hammer. It is designed to remove the c/v joints from the c/v shaft. Not for removing the c/v joints and shaft from the transaxle and will not work in this case.

One however—baker U.S. Pat. No. 5,095,604 could possibly do the job but this is not any of their claims. It is adjustable in either one or two places and is more subject to brake under the strain provided by most shaft removals. Especially when hammering on sideways. It is not made for that. At the very least it would not adjust as nicely after some use. In closing with baker, it costs more to make. They do more to manufacture it.

### SUMMARY

This invention is a forked wedge separator. It goes between the transaxle and the c/v halfshaft. Usually the flat part on the back side of the tapered end of the fork goes against the transaxle. However, there are models where there has been an advantage to putting the tapered edge against the transaxle. So a mechanic should be at liberty on how the tool works best for him/her on any giver model. By hitting on the butt of The Axle Popper. The tool is driven straight in. Once the tool is in it is then hit on the side of the butt of the handle to finish knocking out the c/v halfshaft from the transaxle. On some models the c/v joint housing is far enough away from the transaxle that The Axel Popper can slide straight in without any hammering on the butt of the handle. In this case you need only to hit on the side of the butt of the handle. (Driving the shaft out from the transaxle) or use a shim version of the tool (same tool but without a taper) in combination with the tool. An Axle popper with a handle style that fits an air hammer is also available. It can be used by a prying like action. With its forked edge, The Axle Popper is supported on both sides and gives even pressure to each side of the joint housing. This helps prevent slipping and keeps the shaft from going into an angled to one side position which happens when using a regular prybar. This will only lock in harder a hard to get out shaft. The Axle Popper will force out even the most stubborn shaft. With the striking of a hammer or any hitting object. The Axle Popper is now doing must of the work for you. Much more safe than pushing hard on a car. The shorter handled version allows mechanics working on the ground or in a hard to get to spot, to work with more comfort, and success. To those using a car lift. They have the choice of longer handled versions for comfort and safety. (Possible hand hammering from the swing room avalable). Nothing changes from size to size with The Axle Popper. Only the handle length. (With exception of any special order from a customer concerning size, shape or style). There are currently 4 sizes avalable. The 9″, 12″, 15″, and 18″. The inches are measured by the overall length of the tool. The Axle Popper has other names such as The c/v halfshaft wedge, The Golden Rod, (Do to its coloring after final processing.) Or any combination of these words. The Axle Popper is the most popular. The Axle Popper does get in where other specialty tools can't. It is not assembled. Needs less space to be used. Very important in repairing today's cars. It costs less to manufacture for it is a simply cut out and tapered one piece tool. It is made especially for the job and holds up great under the stress of removing a a halfshaft from a transaxle. Even when being hammered in the sideways form. The Axle Popper will work great on a said 80 to 85% of all front wheel drive and rear wheel drive with front wheel drive set up transaxles in this one form without any special ordering of shape or size.

### BRIEF DESCRIPTION OF SEVERAL VIEWS OF THE DRAWING

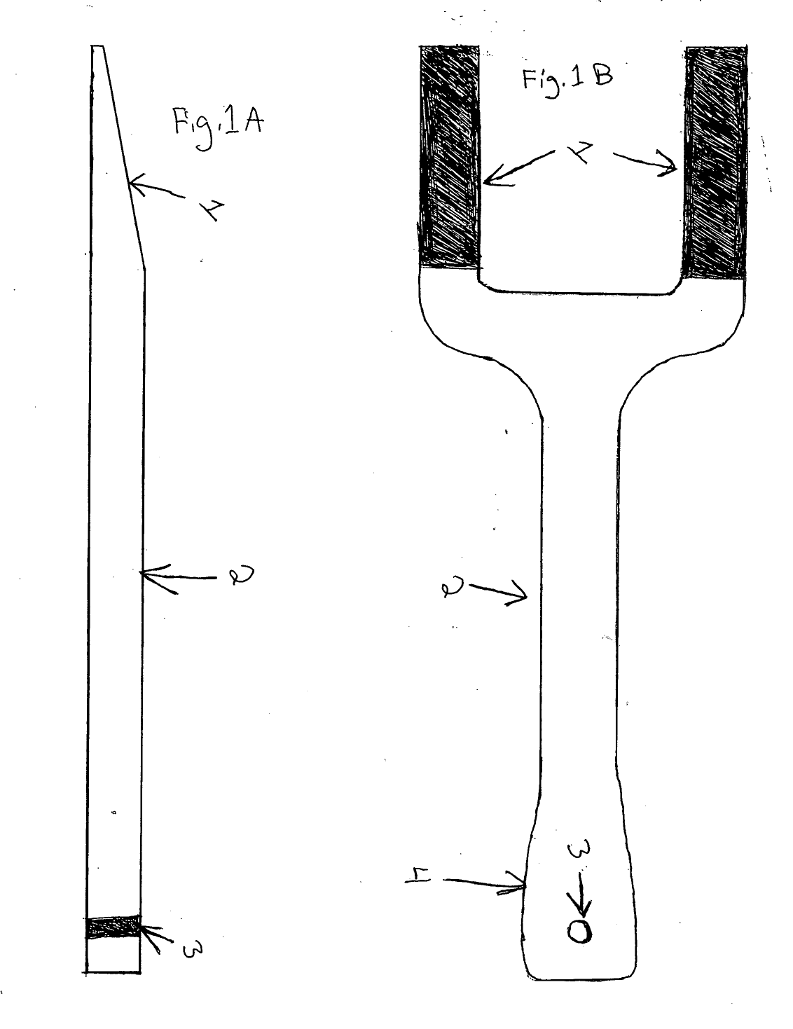

(FIG. 1A) Is a side view of The Axle Popper. 1 is the tapered section of the forks on the tool. 2 is the handle of the tool. 3, the shaded area, is a 5/16 hole drilled through the handle. This is life size drawing of the 9″ tool. All measurements taken from this drawing will make the actual tool.

(FIG. 1B) is a top view of The Axle Popper. 1, the shaded area, is the tapered section of the forks. 2 is the handle of the tool. 3 is a 5/16 hole drilled through the handle. For hanging and or binding together. 4 is a widened section of the handle. Which helps prevent tool slipping and hand hammering. This too is a life size drawing of the 9″ tool. All measurements taken from this drawing will make the actual tool. For longer handled tools, to each size up, 3″ in length is added to the skinniest part of the handle only.

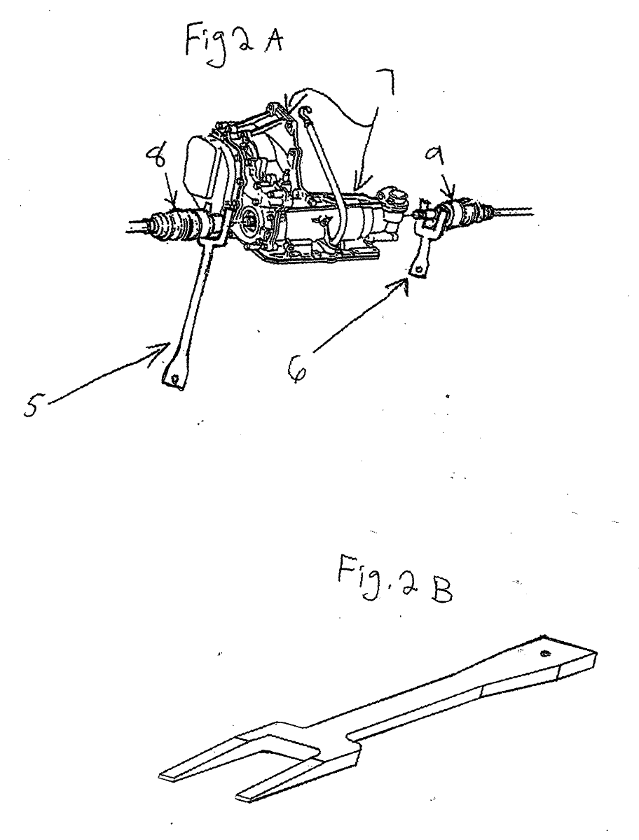

(FIG. 2A) Shows a typical front wheel drive transaxle set up. The Axle Popper in this picture shows where it is inserted for halfshaft removal. 5 is the 18″ long tool. 6 is the 9″ long tool. 7 is the transaxle. 8 is the left side c/v halfshaft. 9 is the right side c/v halfshaft.

(FIG. 2B) is a 3-D view of The Axle Popper.

### DETAILED DESCRIPTION OF THE INVENTION

### DESCRIPTION OF THE PREFERRED EMBODIMENT

Although there are many ways to manufacture the simple toll of The Axle Popper. Currently the most inexpensive in mass-producing is as follows. A ½″ thick 4′×8′ sheet of hot roll pickle & oil, which is a mild steel, (# A-36) is placed on a burn table used for cutting said sheet of steel. A program for cutting out the design of The Axle Popper is used to guide a torch, plasma cutter or laser. This can be updated as technology progresses. Whether it be a 9″, 12″, 15″, 18″ or any shape or size special ordered by a consumer, it is cut out as many times as possible on the sheet of steel or to fit any order. A U shaped fork is made on one end.

(FIG. 1B # 1) The U shape measures 3″ from one out side edge of the fork to the other. Each fork is ½″ in width. Leaving 2″ from the inside edge of one fork to the other. From the end of the tool, fork side, to the inside edge of the C shape of the U forks it measures 2½″. This U shape is used to accommodate structure needed to get between the the transaxle and c/v halfshaft to hold it firmly and successfully pop it out. (FIG. 2A #7 #8 & #9) This U is tapered. (FIG. 1A #1 & 1B #1) Leaving atleast 1/16″ on the tip, keeps it blunt for greater safety on behalf of consumers and to keep it uniform during processing. The taper goes from the tip of the U on the end tool, up the forks toward the handle for 2⅛″. (FIG. 1B #1) The taper is used when separating a c/v housing from a transaxle when c/v is very close to the transaxle. (When about any angle would make do as a taper, the 2⅛″ measurement stop for taper is a great midrange taper and angle for all model's of cars.) This is done by hitting on the butt of the handle and driving the tool straight in. (FIG. 2A #5 & #6) Then it is hit on the side of the butt of the handle to finish knocking it out. (FIG. 1A #3) When the inner c/v housing is far enough away from the transaxle and the tools U shape taper slides all the way in place without any hammering. The tool is just hammered on the side of the butt of the handle. (FIG. 1A #3) Taking c/v halfshaft out of transaxle in one step. (FIG. 2A #5 & #6) (My shim version of the tool can also be used in combination with The Axle Popper to take up extra space between a c/v housing and its related transaxle). {same exact tool but without a taper} The hammering can be done by any hitting device such as a claw or sledge hammer. But not limited to such. (an air hammer can be used with The Axle Popper's air hammer style handle) The taper is made by the tool being clamped down to be grinded or to be sawed off. The grinder or saw is run over the fork end of the tool making the angle mentioned above by measurement given. This step is skipped when making the shim version of the tool. When being burned out the tool is also given a handle. (FIG. 1A #2 & 1B #2) When a mechanic is working on a car, from underneath, and the car is on or near the ground. He/she needs a shorter handle so they can have room to swing at the tool. Thus the 9″ pictured in (FIG. 1A & 1B) in life size.

When a mechanic is working on a car that is up on a car lift. A longer handle is used for comfort. So a mechanic does not have to reach way up into a car. With more handle one is more likely to not strike one's hand with the extra swinging room provided when a car is on a lift. The Axle Popper can also be used in a prybar fashion. Supported on both sides of the c/v shaft to come out, it is more safe than any regular prybar by helping to prevent slippage. This can test how hard any given shaft will be to come out. Though it works best with a hammer in the prescribed fashion. With the different sizes available, 9″, 12″, 15″, & 18″. Nothing changes but the handle length, 3″ per size. A mechanic can choose the size their most comfortable with or will need in any given circumstance. They can special order any shape or size they think will be helpful to them.

When the top view is observed, the butt of the handle is made slightly wider than the handle itself (FIG. 1B #4). This is done to prevent the tool from slipping out of one's hand and to help prevent hand hammering by giving a larger hitting area. (When the tool is made for use in combination with an air hammer. It is placed on a lathe and spun against a cutter until it conforms to the specifications needed to fit on an air hammer. (Still the handle lengths all remain the same). The handle's butt is placed in a drill press jig, set up to lay the drilling spot under the drill bit. The tool is clamped down. A 5/16″ hole is made in the center of the handles butt (FIG. 1B #3). It goes all the way though the handle to the other side. The hole is good for hanging up the tool in storage. Also for bolting two tools back to back if necessary. A 5/16″ hole is a great average size for must occasions. Most importantly the hole is needed for quick processing. It has been claimed that it is much more easy to get a hold of the tool during manufacturing. Especially when the barrel plating is being done. The barrel plating is done after a final grinding or wire brushing is done to clean up any steel burrs left on the tool from processing. The tool is put in a barrel with a zinc plating substance and a yellow dichromate is used. This gives it a gold like color. The plating is done to give the tool a nice look and to prevent it from rusting on the shelf while waiting to be sold. The plating will keep the tool looking as nice as possible while being owned and used by a mechanic and is a good price for a good type of plating.

Certain tool companies would like to see this tool hardened for greater life expectancy and durability. The tool is baked until it reaches the harden specification wanted by those companies. The baking removes steel impurities. Thus making it harder. If the tool is to be hardened, it has to be done before the plating is done. A hardened tool is more difficult to plate. The hardening and difficulty in plating after such raises the cost and quality of the tool. This would be sold to the professional mechanic. Otherwise without hardening is the way to go for the casual, backyard or a dollar saving mechanic. In comparison to previous inventions, whether patented or not there are specialty tools designed to do the job of halfshaft removal from the transaxle. Like the J-35910. It has to be assembled to a slide hammer everytime you need to use it. It requires generous space to be used and is clumsy to use. In a lot of cases it wont even fit between the transaxle and the c/v joint housing to do the job of removing the shaft. The Axle Popper is put in place without a necessary assembling. Using a very small amount of space it can fit in between the some of the tightest places for removing the shaft from the transaxle. Far from being clumsy. The Axle Popper is less expensive not needing a slide hammer and pricey attachments. It can be used with any hand held hammer or hitting device sold at many stores. (not specialty stores). Or used like a prybar all by itself. There are other forked wedge separators. None are specifically made to do the job of removing c/v halfshafts from the transaxle. And they will not remove the shaft by reason of not fitting. There is one forked wedge separator that could do the job of shaft removal. BAKER U.S. Pat. No. 5,095,604. This is not their claim and there would be flaws in using their tool for this job. Their tool is adjustable in one or two places. This makes the tool easier broken and harder to adjust after some use. This is mainly do to the need to hammer the tool in a sideways fashion. To remove or to finish removing the halfshaft. The BAKER tool is designed for hammering straight into an object for the separation of two objects. It is not made for hammering sideways. The Axle Popper is one piece. It is not adjustable, except in design and is less likely to brake especially when hammered in the sideways fashion. The Axle Popper costs less to make because less is done to create it. PATTERSON U.S. Pat. No. 5,103,544 should not be confused here with The Axle Popper. It removes the c/v joints from the c/v shaft not the c/v joints and shaft from the transaxle. The inventions mentioned here are so different from The Axle Popper, that improving on them would not have been the main focus. Other than that of BAKER. (Different handle lengths, one piece tool, shim (same but without taper), air hammer able and or special orders of shapes and sizes from consumers). The Axle Popper is made from scratch. I had a big problem of removing the c/v halfshafts from the transaxle and i made a solution. What has been improved on here is the job of removing a c/v halfshaft from the transaxle. At a good quality and cost. If you doubt this or would investigate whether or not this is true, i invite you to find out how much easier i have made the likes of this job to do for myself and others.

1. A way of removing a c/v halfshaft from a front wheel drive transaxle and rear wheel drive with front wheel drive transaxle set ups by use of a forked separator or a forked wedge separator.

2. A forked wedge separator in claim one is driven straight in between the inner c/v joint housing and the transaxle by use of any hand held hammer or hitting device, hitting it on the handles butt.

3. Step two a forked wedge separator is driven sideways away from the transaxle toward the c/v halfshaft or away from the c/v halfshaft toward the transaxle by hitting the butt of the handle sideways in these directions to finish taking out a c/v halfshaft.

4. Hitting a forked separator or a forked wedge separator in these sideways fashions of step two to take out the c/v halfshaft in one step. (sometimes the inner c/v joint housing is far enough away from the transaxle so that the driving straight in method is not required as a forked separator or a forked wedge separator slides in the straight method all the way with ease)

5. Bolting two forked separators, forked wedge separators or a forked separator and a forked wedge separator back to back when the c/v joint housing is far enough away from the transaxle that the filling up of the space is needed for hammering the tools straight in and then sideways or just sideways when the straight in fashion is not required.

6. The manufacturing of any shape or size tool special ordered from a consumer, or made by me and used in the straight in and sideways fashion or just the sideways fashion to remove a c/v halfshaft from a transaxle concerning a forked separator or a forked wedge separator.

7. Using a forked separator(s) or a forked wedge separator(s) sized to accommodate the structuring involved needed to remove a c/v halfshaft from a transaxle or a transaxle from a c/v halfshaft whether in whole or in part, whether the automobile or transaxle is on or near the ground, whether the automobile or transaxle is the air on a lift or lifting device and a longer or shorter handled forked separator(s) or a forked wedge separator(s) is used in step one or two therein.

8. Using a forked separator(s) or a forked wedge separator(s) in a prying like action to remove a c/v halfshaft from a transaxle or a transaxle from a c/v halfshaft whether in whole or in part.

9. A hand held tool that makes the job removing a c/v halfshaft from a transaxle very easy and more safe

10. Names of the tool(s) i have invented are The C/v Halfshaft Popper, The Axle Wedge, shim, The Golden Rod, The Axle Popper, The Halfshaft Prybar and any mix or match of these titles.
